(19) United States
(12) Patent Application Publication
(10) Pub. No.: US 2006/0215645 A1
(43) Pub. Date: Sep. 28, 2006

(54) Setting control device for layer 2 device

(75) Inventor: Hideki Kangyu, Kawasaki (JP)

Correspondence Address: BINGHAM MCCUTCHEN LLP, 3000 K STREET, NW, BOX IP, WASHINGTON, DC, 20007, US

(73) Assignee: Fujitsu Limited

(21) Appl. No.: 11/188,853

(22) Filed: Jul. 26, 2005

(30) Foreign Application Priority Data
Mar. 25, 2005 (JP) 2005-89248

(51) Int. Cl. H04L 12/50; H04Q 11/00

(52) U.S. Cl. 370/360

(57) ABSTRACT

The invention relates to a layer 2 network. The invention provides a setting control device for layer 2 devices that simultaneously sets the same data to plural layer 2 devices provided in a network such as a broadband Ethernet and an enterprise LAN. The setting control device for layer 2 devices includes: a unit that confirms that a reception frame is a control frame including setting control information of layer 2 devices; a unit that transfers the control frame including the setting control information, after the control frame is confirmed; and a setting unit that sets the setting control information to the own layer 2 device, after the control frame is transferred. The transfer unit broadcasts the control frame to be transferred.

### BACKGROUND OF THE INVENTION

1. Field of the Invention

The present invention relates to a layer 2 network. Particularly, the invention relates to a device and a method for carrying out a setting control of layer 2 devices such as bridges that are used for a broadband Ethernet service or in a local area network (LAN) within an enterprise.

2. Description of the Related Art

For a broadband Ethernet service provided by a telecommunications carrier or in an enterprise LAN, there has been carried out a quality of service (QoS) control or the like for prioritizing transfer of an audio signal that requires real-time transfer of audio/data signals within the same area (i.e., a layer 2 network) that is served by a router. Consequently, QoS control data, of the same content, must be sent to all the layer 2 devices, such as bridges, within the layer 2 network.

Conventionally, a personal computer is connected to layer 2 devices via a serial port and a universal serial bus (USB), and data are set to the layer 2 devices individually using a telnet application of the personal computer or a Web browser setting screen displayed on a display screen. Alternatively, a network managing device such as a server is disposed in the network, and the server accesses each layer 2 device to set data of the same contents to each layer 2 device.

The following network setting method, different from the above router setting, is proposed in Japanese Patent Application Unexamined Publication No. 7-162448. First, pieces of setting information of plural routers are integrally registered in a host terminal connected to a network. Next, a nearest router requests the host terminal for its own setting information, obtains this information, and sets this information in the router. Thereafter, routers at subsequent stages sequentially execute a similar processing via routers to which data are already set, thereby completing the setting of data in all the routers.

There is also a method of making a center router automatically set a remote router that is connected by a point-to-point (P-P) line, as proposed in Japanese Patent Application Unexamined Publication No. 2000-324170.

However, when an operator manually sets and controls layer 2 devices using a telnet application or a Web browser setting screen, the number of layer 2 devices increases in a medium to large scale network, and the work load of the operator also increases.

When a network managing device such as a server is used, a monitoring network for enabling the server to monitor the layer 2 devices needs to be built in the existing network (inbound) or in an external network (outbound). This method has a problem of increasing the number of processes in designing a system and increasing the device management cost at the time of introducing the system.

When a router is used, this cannot meet a loop configuration formed between layer 2 devices in a mesh-type layer 2 network. On the other hand, when a star-type network having a center router at the center is used, a mesh-type layer 2 network in an optional configuration cannot be used.

### SUMMARY OF THE INVENTION

In the light of the above problems, it is an object of the present invention to provide a layer 2 setting control device and a layer 2 setting control method capable of simultaneously setting data, of the same content, into plural layer 2 devices within a layer 2 network, by using an Ethernet control frame.

According to one aspect of the present invention, there is provided a setting control device for layer 2 devices constituting a layer 2 network. The setting control device includes: a unit that confirms that a reception frame is a control frame including setting control information of layer 2 devices; a unit that transfers the control frame including the setting control information, after the control frame is confirmed; and a setting unit that sets the setting control information to the own layer 2 device, after the control frame is transferred.

According to another aspect of the invention, the layer 2 network is a mesh-type network, wherein the transfer unit broadcasts the control frame to be transferred. According to still another aspect of the invention, the control frame further includes transfer number of times information that is updated each time when the control frame is transferred, and the setting control device further includes a unit that abandons a control frame including the transfer number of times information when the transfer number of times information reaches a predetermined value.

According to still another aspect of the invention, the control frame further includes frame intrinsic information, and the setting control device further includes a unit that detects a control frame including the same frame intrinsic information and abandons the control frame. According to still another aspect of the invention, the setting control device further includes a unit that reports to the first transmitter of the control frame whether the control frame has been successfully transferred.

According to still another aspect of the invention, there is provided a setting control method for layer 2 devices that constitute a layer 2 network. The setting control method includes: a step of confirming that a reception frame is a control frame including setting control information of layer 2 devices; a step of transferring the control frame including the setting control information, after the control frame is confirmed; and a step of setting the setting control information to the own layer 2 device, after the control frame is transferred.

According to the present invention, the same data can be simultaneously set to all layer 2 switches 2-1 to 2-5 at a high speed. According to the present invention, the same data can be set in the same policy to all layer 2 devices constituting a network at a high speed, without using an external network management system or an Internet Protocol (IP) network.

According to the present invention, a high-speed transfer is achieved using a broadcast and a physical address (i.e., a media access control (MAC) address) at the same time. Moreover, after transferring a received control frame to the next stage, data thereof is set to the own switch. Therefore, the frame can be transferred at a higher speed. The information concerning a network configuration that is required in the present invention is only the number of stages (i.e., the number of hops) from a layer 2 switch to which a control terminal is connected. Information of a network configuration and device intrinsic information such as an IP address, routing information, a router name, etc. that are required in a layer 3 network are not necessary in the present invention.

Further, according to the present invention, by giving a unique sequence number to each control frame, redundant reception and redundant processing due to a mesh configuration, and an infinite loop, can be avoided. A reach area (i.e., the number of hops) of a control frame is limited, thereby preventing unnecessary use of a band and the occurrence of much traffic.

### BRIEF DESCRIPTION OF THE DRAWINGS

The present invention will be more clearly understood from the description as set forth below with reference to the accompanying drawings, wherein

FIG. 1 is a configuration diagram of a layer 2 network according to the present invention;

FIG. 2 is a configuration diagram of a layer 2 switch according to the present invention;

FIG. 3 is a structure diagram of a format of a control frame according to the present invention;

FIG. 4 is an explanatory diagram of field functions of the control frame;

FIG. 5 is a flowchart of a frame processing carried out by a control frame processor; and

FIG. 6 is a flowchart of a frame processing carried out by a central processor.

### DESCRIPTION OF THE PREFERRED EMBODIMENTS

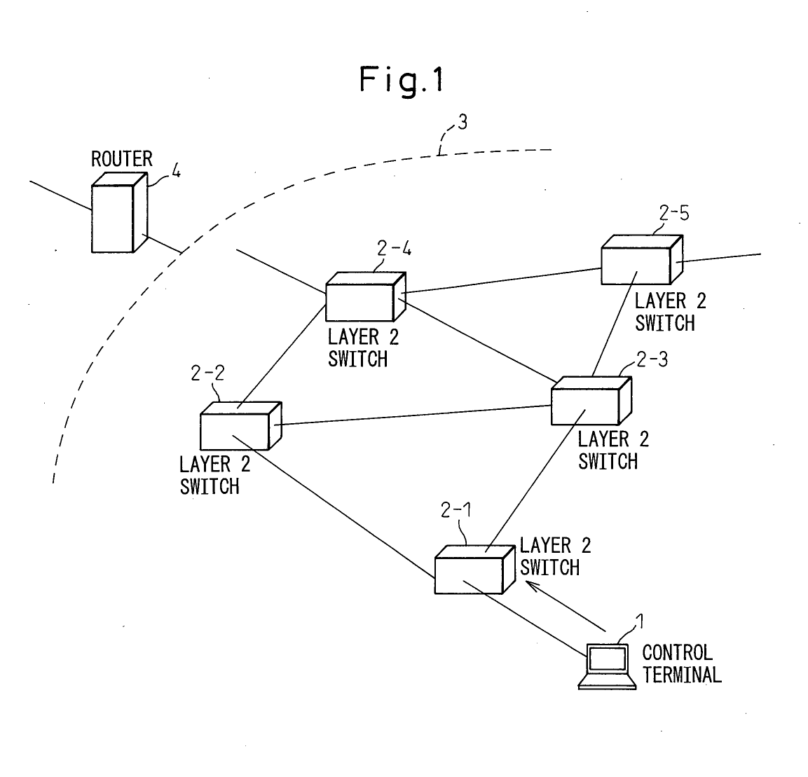

FIG. 1 is a configuration diagram of a layer 2 network according to the present invention.

As shown in FIG. 1, plural layer 2 switches (i.e., Ethernet switches) 2-1 to 2-5 that are connected to each other in a mesh are present within a layer 2 network 3. A control terminal 1 such as a personal computer is connected to the layer 2 switch 2-1 as an optional one of the layer 2 switches. The layer 2 network 3 is connected to other layer 2 network via an external router 4.

A “mesh-type network” refers to one mode of a network constructed by unspecified optionally-connected devices. Therefore, a physical loop route can be formed between the devices. An operator transfers setting data and control data that are common to the layer 2 switches 2-1 to 2-5, to the layer 2 switch 2-1, using a telnet application operated in the control terminal 1 or a Web browser setting screen displayed on a display screen.

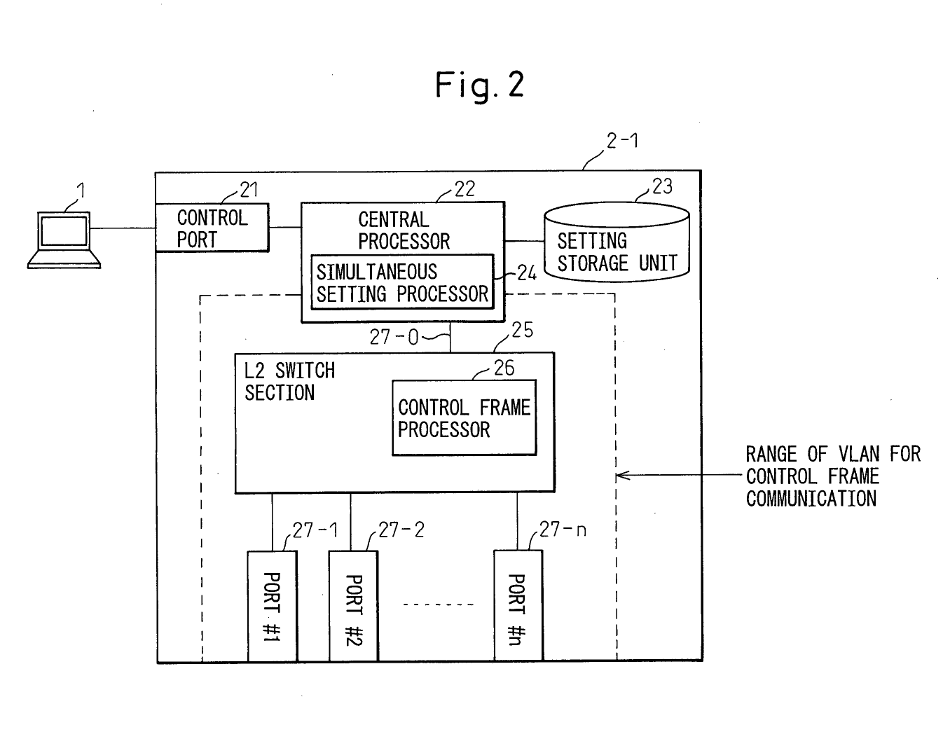

FIG. 2 is a configuration diagram of a layer 2 switch according to the present invention. While FIG. 2 shows a configuration of the layer 2 switch 2-1 shown in FIG. 1, other layer 2 switches 2-2 to 2-5 also have configurations similar to this configuration.

In FIG. 2, a control port 21 is a serial/USB connection port to which the control terminal 1 is connected. The control terminal 1 inputs setting data and control data that are common to the layer 2 switches 2-1 to 2-5 to a central processor 22 via this control port 21. Instead of using the control port 21, any one of the general-purpose ports 27-1 to 27-n of the layer 2 switch 2-1 can be also used for this purpose.

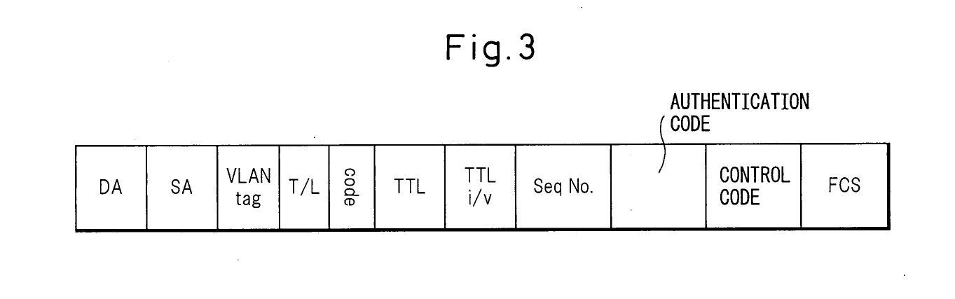

A simultaneous setting section 24 inside the central processor 22 generates a control frame for a simultaneous setting control according to the present invention and carries out a decision processing, in addition to the normal layer 2 processing including a bridge function. In the present invention, the Ethernet control frame shown in FIG. 3 prescribed in IEEE (Institute of Electrical and Electronics Engineers) 802.3 is used. The central processor 22 is connected to a layer 2 switch section 25 via an internal port (i.e., an Ethernet port) 27-0.

The layer 2 switch section 25 is connected to the general-purpose ports (i.e., Ethernet ports) 27-1 to 27-n, and executes a layer 2 switching processing using a media access control (MAC) address and a virtual LAN (VLAN) prescribed in the IEEE 802.1Q. The layer 2 switch section 25 according to the present invention includes a control frame processor 26.

The control frame processor 26 identifies the control frames coming from the internal port 27-0 and the general-purpose ports 27-1 to 27-n, and processes the control frames. In the present example, a control VLAN is set to all the ports of the internal port 27-0 and the general-purpose ports 27-1 to 27-n, thereby separating a communication route of the control frame from a communication route of other normal frames. A setting storage unit 23 is a memory that stores the setting data and the control data of the layer 2 switch 2-1.

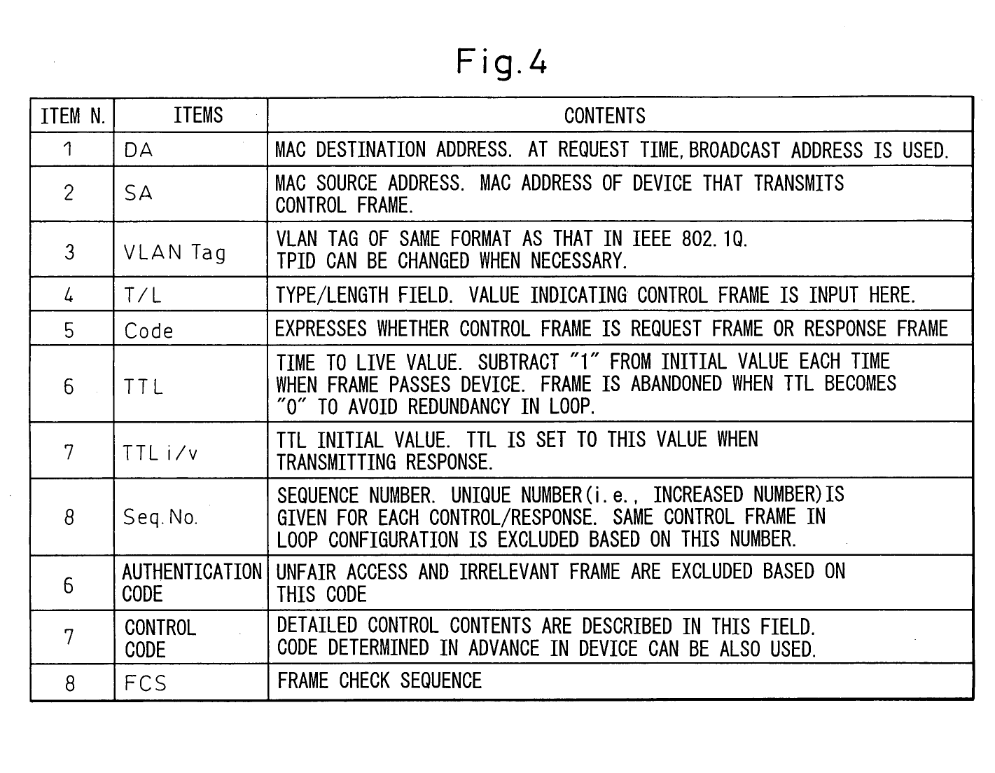

FIG. 3 is a structure diagram of a format of a control frame according to the present invention. FIG. 4 is an explanatory diagram of functions of fields of the control frame. The format and the functions are based on the prescriptions of the IEEE b 802.3 l and the IEEE 802.1Q.

In a DA (destination address) field, a MAC address of a destination device of a control frame or a broadcast address not specifying a destination device is written. In an SA (source address) field, a MAC address of a transmission device of a control frame is written.

In a VLAN Tag field, a VLAN tag of the same format as that prescribed in the IEEE 802.1Q is written. This field is used to separate a segment (i.e., a VLAN for a control frame) to which the control frame used in the present invention belongs from a segment (i.e., a VLAN for a normal frame other than the control frame) to which other data communication frame belongs. In a T/L (type/length) field, a unique value indicating that a frame is a control frame used in the present invention is written.

In a code field, whether a frame is a control request frame or a control response frame is written using a one-bit flag value (1/0). In a TTL (time to live) field, time (i.e., a number of hops) during which the control frame can remain is written. This field prevents the control frame from limitlessly spreading within the layer 2 network or limitlessly circulating in the loop route. An initial value of the TTL is written into a TTLi/v (TTL initial value) field. One is subtracted from a TTL value each time when a control frame passes one layer 2 switch. When a layer 2 switch detects a control frame having a TTL value “0”, this layer 2 switch abandons this control frame.

In a Seq. No. (sequence number) field, a unique number is written for each control or response. When a control frame of the same sequence number is received in duplicate, presence of a loop route within the network can be detected. One of the control frames received in duplicate is abandoned.

In an authentication code field, an authentication code for deciding an unfair access or an erroneous access by a third person is written. In a control code field, a type of a control request command, setting data, and control data are written. In an FCS (frame check sequence) field, a cyclic redundancy check (CRC) code or the like to detect an erroneous reception is written.

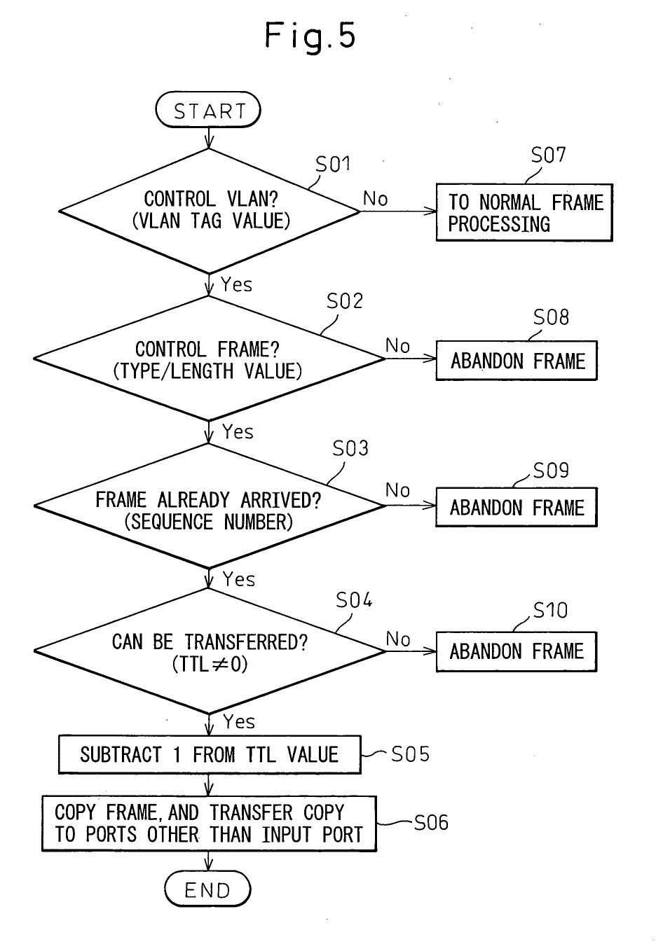

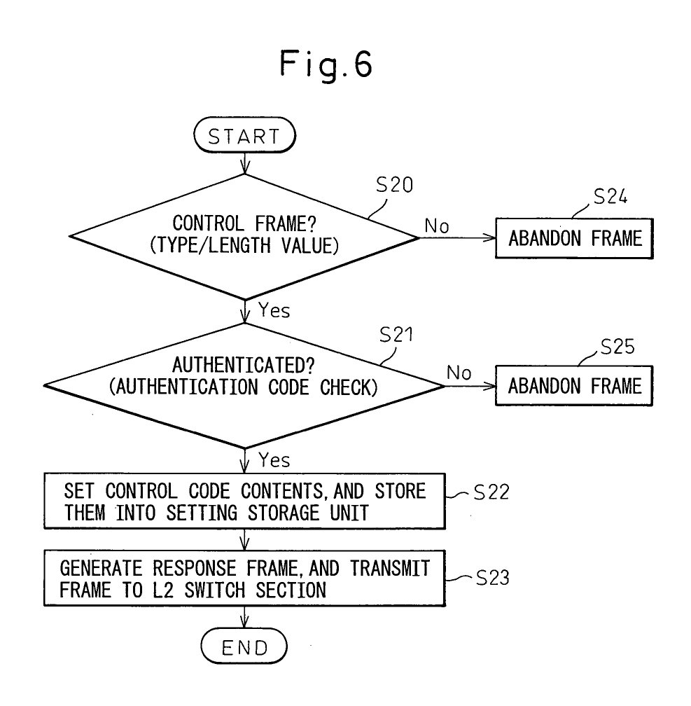

Frame processings according to embodiments of the present invention are explained below with reference to FIG. 5 and FIG. 6.

Based on the configuration of the layer 2 network 3 shown in FIG. 1, a transmission of a control frame for instructing a setting of QoS to prioritize audio data, as an example, and a setting of the current time from the layer 2 switch 2-1 to other layer 2 switches 2-2 to 2-5 is explained.

The operator operates the control terminal 1 to give the QoS setting instruction and the like to the layer 2 switch 2-1. When the setting instruction is input to the central processor 22 via the control port 21 of the layer 2 switch 2-1, the central processor 22 reads the instruction contents, stores the setting data contained in the QoS setting instruction into the setting storage unit 23, and reflects the setting contents in the own layer 2 switch 2-1.

The simultaneous setting processor 24 included in the central processor 22 generates a control frame for instructing the QoS setting of the same contents, as that of the layer 2 switch 2-1, to the other layer 2 switches 2-2 to 2-5. In this case, a broadcast address is written into the DA of the generated control frame. The own MAC address is written into the SA. A segment number to which the control frame belongs is written into the VLAN Tag. A specific value indicating the control frame is written into the T/L. A flag value “1” indicating the control request frame is written into the code. A number 3, as an example, indicating the number of hops is written into the TTL and the TTLi/v respectively. A unique number is written into the Seq. No. A predetermined decision number is written into the authentication code. A setting command and necessary setting data are written into the control code.

The control frame generated above is input to the control frame processor 26 via the internal port 27-0 connecting between the central processor 22 and the layer 2 switch section 25. The control frame processor 26 processes the frame arrived from the internal port 27-0 as follows.

FIG. 5 shows one example of a detailed flow of the processing carried out by the control frame processor 26.

In FIG. 5, the control frame processor 26 decides whether the input frame is a frame using the control VLAN, based on the VLAN Tag of the input frame (S01). When, the input frame is not a frame using the control VLAN, the control frame processor 26 carries out a normal data frame processing (S07). The control frame processor 26 decides whether the frame is a control frame based on the T/L value (S02). The control frame processor 26 decides whether the frame is the frame that already arrived, by checking the coincidence of the sequence numbers in the Seq. No. (S03). Last, the control frame processor 26 decides whether the TTL value is “0” (S04).

When the results of decisions made at steps S02 to S04 are No, the input frames are abandoned at steps S08 to S10 respectively. In other words, when the frame is not a control frame, the frame is abandoned as an unknown frame. When the same frame has already arrived before, the frame arrived this time is abandoned in order to avoid the redundant processing of the same control frame. When the TTL value is equal to “0”, the frame is abandoned in order to prevent a limitless spread of the control frame.

In the decision on the already-arrived frame (S03), the sequence number of the frame that first reaches the control frame processor 26 is kept during a constant period. Another frame, having the same sequence number, that arrives during this holding period is abandoned (S09). Even when the frame is not abandoned based on the decision of the already-arrived frame, when the frame has the TTL value “0” indicating that the frame exceeds the life period in the decision of the TTL value, this frame is abandoned (S04 and S10).

On the other hand, when the frame is a control frame (S02), when the frame has not arrived before (S03), and also when the TTL value is not equal to “0” (S04), one is subtracted from the TTL value of the control frame to obtain the TTL value=“2” (S05). The control frame having the TTL value “2” is broadcasted from all ports, i.e., the general-purpose ports 27-1 to 27-n to which the VLAN corresponding to the VLAN Tag value is set, except the port to which the frame is input, i.e., the internal port 27-0 (S05 and S06).

The layer 2 switches 2-2 and 2-3 at the next stage input the broadcasted control frames to the general-purpose ports 27-1 to 27-n to which the control VAN is set. The input control frames are input to the control frame processor 26 through the layer 2 switch section 25. Thereafter, the control frame processors 26 of the layer 2 switches 2-2 and 2-3 execute the processing similar to that explained in the control flow in FIG. 5 (S01 to S10).

As a result, in the layer 2 switches 2-2 and 2-3, the general-purpose ports 27-1 to 27-n corresponding to other control VLAN excluding the general-purpose port to which the control frame is input broadcast the control frame having the TTL “1”. The control frame that is broadcasted to the outside is input to the general-purpose ports 27-1 to 27-n corresponding to the control VLAN of the layer 2 switches 2-4 and 2-5 at the next stage.

On the other hand, in the present example, the same control frame is also output to each internal port 27-0 of the switches 2-2 and 2-3 respectively (S05 and S06). The central processor 22 executes the following processing to the control frame that is input through the internal port 27-0.

FIG. 6 shows one example of a flowchart of the processing of the frame transferred to the central processor 22.

In FIG. 6, the central processor 22 decides whether the frame transferred to the central processor 22 is a control frame based on the T/L value (S20). When the frame transferred to the central processor 22 is a control frame, the central processor 22 decides whether an unfair access (S21) is performed based on the authentication code. When the decision made at each of step S20 and step S21 is No, the central processor 22 decides that the input frame is not a correct control frame, and abandons the input frame (S24 and S25).

When the decision made at both steps S20 and S21 is Yes, the central processor 22 reads the instruction contents, and sets the QoS of prioritizing the audio data into the setting storage unit 23 in order to reflect the setting contents in the own layer 2 switch. As a result, the central processor 22 sets the same configuration and the same control as those of the layer 2 switch 2-1 as the transmitter of the control frame, to the layer 2 switches 2-2 and 2-3 respectively (S22).

After the above setting, the central processor 22 instructs the simultaneous setting processor 24 to prepare a response frame. The simultaneous setting processor 24 generates a response frame consisting of the same format as that of the control frame shown in FIG. 3, and transmits the generated response frame to the layer 2 switch section 25 via the internal port 27-0 (S23). In this example, the MAC address of the layer 2 switch 2-1 is written into the DA of the response frame. The MAC address is written into the SA. A segment number to which the control frame belongs is written into the VLAN Tag. A specific value identifying the control frame is written into the T/L. A flag value “0” indicating the control response frame is written into the code. A TTLi/v value “3” of the received control frame is written into the TTLi/v. A TTLi/v value minus the received TTL value plus one is written into the TTL. A sequence number of the received control frame plus a constant value is prepared as a number which is not redundant with the number of the request frame, and this prepared number is written into the Seq. No. A predetermined decision value is written into the authentication code. An ACK/NACK response and a reason parameter, if necessary, are written into the control code.

When the response frame is input to the layer 2 switch section 25 via the internal port 27-0, the layer 2 switch section 25 executes the same steps of processing at S01 to S10 as those shown in FIG. 5. In this case, because the MAC address (DA) of the layer 2 switch 2-1 is specified as the destination of the response frame, the layer 2 switch section 25 transmits the response frame of the TTL value “1” to the general-purpose ports 27-1 to 27-n excluding the internal port 27-0, by using the ordinary MAC address learning table or the like (S05 and S06). This response frame finally reaches the layer 2 switch 2-1 as the control request origin. The steps of processing shown in FIG. 5 and FIG. 6 are also executed in the layer 2 switch 2-1, and the setting of each layer 2 switch is notified to the central processor 22. The operator can confirm whether the setting is carried out, through the control terminal 1.

As described above, according to the present example, after the control frame is transferred to the next stage (i.e., the next hop), the setting to the own switch and the response are executed. Therefore, the control frame can be transferred at a high speed. On the other hand, the layer 2 switches 2-4 and 2-5 at the next stage receive the control frames from the switches 2-2 and 2-3, and execute the same steps of processing as those shown in FIG. 5 and FIG. 6 executed by the switches 2-2 and 2-3. As a result, the instructed setting contents are reflected in the own switches 2-4 and 2-5. The setting result is returned in the response frame to the layer 2 switch 2-1 as the transmitter of the control frame.

According to the above embodiment, data of the same contents can be set simultaneously to all the layer 2 switches 2-1 to 2-5 at high speed. The operator can confirm whether the data have been set to all the layer 2 switches in the network, through the control terminal 1. According to the present embodiment, the same data can be set in the same policy to all layer 2 devices constituting a network at a high speed, without using an external network management system or an IP network.

Further, by giving a unique sequence number to each control frame, a redundant reception and a redundant processing due to a mesh configuration, and an infinite loop, can be avoided. In the example shown in FIG. 1, the layer 2 switch 2-4 can redundantly receive the same control frames from both the layer 2 switches 2-2 and 2-3. In this case, a control frame that is received last is abandoned (S03 and S09 in FIG. 5). Further, a control frame of which TTL value becomes “0” after repeatedly passing the layer 2 switch is automatically extinguished from the network (S04 and S10 in FIG. 5). Therefore, the reach area (i.e., the number of hops) of a control frame is limited, thereby preventing unnecessary use of a band and occurrence of traffic.

When the processing similar to that according to the present invention should be achieved using a layer 3 switch (i.e., a router or the like), the processing of a network layer of an open system Interconnection (OSI) reference model must be executed, and this increases the processing time. On the other hand, according to the present invention, a high-speed transfer is achieved using a broadcast and a physical address (i.e., an MAC address) at the same time. Moreover, after transferring a received control frame to the next stage, data is set to the own switch. Therefore, the frame can be transferred at a higher speed. Consequently, at the time of setting time in a device, time can be set by minimizing an error in the total network devices.

The information concerning a network configuration that is required in the present invention is only the number of stages (i.e., the number of hops) from a layer 2 switch to which a control terminal is connected. It is not necessary know information of a network configuration and device intrinsic information. Therefore, an IP address, routing information, a router name, etc. that are required in a layer 3 network are not necessary in the present invention.

What is claimed is:

1. A setting control device for layer 2 devices that constitute a layer 2 network, the setting control device comprising:
a unit that confirms that a reception frame is a control frame including setting control information of layer 2 devices;
a unit that transfers the control frame including the setting control information, after the control frame is confirmed; and
a setting unit that sets the setting control information to the own layer 2 device, after the control frame is transferred.

2. The setting control device for layer 2 devices according to claim 1, wherein
the layer 2 network is a mesh-type network, and
the transfer unit broadcasts the control frame to be transferred.

3. The setting control device for layer 2 devices according to claim 2, wherein
the control frame further includes transfer number of times information that is updated each time when the control frame is transferred, and
the setting control device further comprises a unit that abandons a control frame including the transfer number of times information when the transfer number of times information reaches a predetermined value.

4. The setting control device for layer 2 devices according to claim 2, wherein
the control frame further includes frame intrinsic information, and
the setting control device further comprises a unit that detects a control frame including the same frame intrinsic information, and abandons the control frame.

5. The setting control device for layer 2 devices according to claim 2, the setting control device further comprising a unit that reports to the first transmitter of the control frame whether the control frame is successfully transferred.

6. A setting control method for layer 2 devices that constitute a layer 2 network, the setting control method comprising:
a step of confirming that a reception frame is a control frame including setting control information of layer 2 devices;
a step of transferring the control frame including the setting control information, after the control frame is confirmed; and
a step of setting the setting control information to the own layer 2 device, after the control frame is transferred.

7. The setting control method for layer 2 devices according to claim 6, wherein
the layer 2 network is a mesh-type network, and
the step of transferring includes broadcasting the control frame to be transferred.

8. The setting control method for layer 2 devices according to claim 7, wherein
the control frame further includes transfer number of times information that is updated each time when the control frame is transferred, and
the setting control method further comprises a step of abandoning a control frame including the transfer number of times information when the transfer number of times information reaches a predetermined value.

9. The setting control method for layer 2 devices according to claim 7, wherein
the control frame further includes frame intrinsic information, and
the setting control method further comprises a step of detecting a control frame including the same frame intrinsic information, and abandoning the control frame.

10. The setting control method for layer 2 devices according to claim 7, further comprising a step of reporting to the first transmitter of the control frame whether the control frame has been successfully transferred.
